(19) United States
(12) Patent Application Publication
(10) Pub. No.: US 2011/0015871 A1
(43) Pub. Date: Jan. 20, 2011

(54) INTELLIGENT SENSOR DATA LOGGING SYSTEM

(76) Inventor: Donald Bruce Nuzzio, Ringoes, NJ (US)

Correspondence Address: Benita J. Rohm;Rohm & Monsanto, PLC, 12 Rathbone Place, Grosse Pointe, MI, 48230, US

(21) Appl. No.: 12/733,518

(22) PCT Filed: Sep. 5, 2008
(86) PCT No.: PCT/US08/10409

§ 371 Date: Mar. 5, 2010

Related U.S. Application Data
(60) Provisional application No. 60/967,607, filed on Sep. 5, 2007.

(51) Int. Cl. G06F 19/00; G06F 15/00; G01K 13/00; G01L 7/00

(52) U.S. Cl. 702/22; 702/188; 702/130; 702/50; 702/187

(57) ABSTRACT

A system for acquiring environmental data from a plurality of sensors is provided with a microprocessor having a sensor input for receiving data from a sensor, a memory access port for communicating with a memory system, and an output port for issuing data. Plural sensors each produce associated sensor signals responsive to respective characteristics of an environment. The sensor signals are propagated to the sensor input of the microprocessor, and a memory system is coupled to the memory access port of the microprocessor for storing calibration data associated with the plurality of sensors. A communications arrangement is coupled to the output port of the microprocessor.

### RELATIONSHIP TO OTHER APPLICATION

This application claims the benefit of the filing date of U.S. Provisional Patent Application Ser. No. 60/967,607 filed Sep. 5, 2007 (Foreign Filing License Granted) in the name of the same inventor as herein. The disclosure in the identified United States Provisional Patent Application is incorporated herein by reference.

### BACKGROUND OF THE INVENTION

1. Field of the Invention

This invention relates generally to sensor and data logging systems, and more particularly, to a system for acquiring data from sensors having associated stored parametric and calibration information.

2. Description of the Prior Art

Currently available systems for monitoring or measuring environmental conditions in difficult environments, such as under the sea, generally require individual probes or transduces to that are interconnected in a manner that precludes periodic remote calibration of the transducer probes. Such systems are complex, expensive, and not adequately reliable.

There is a need for a system that integrates data from a plurality of different types of sensors, such as temperature, pressure, and chemical composition data.

There is additionally a need for enabling the timing of, and the controlling of, the sensing function to facilitate the capture of transient data.

A further need that has not been satisfied in the prior art is the ability of a measurement or monitoring system in an inhospitable environment to be controlled by triggering signals derived from other equipments. Conversely, there is a need to enable the apparatus that performs the measurements and the monitoring to issue signals that trigger other equipment into operation.

### SUMMARY OF THE INVENTION

The foregoing and other objects are achieved by this invention, which provides a system for acquiring environmental data from a plurality of sensors. In accordance with the invention, the system is provided with a microprocessor having a sensor input for receiving data from a sensor, a memory access port for communicating with a memory system, and an output port for issuing data. A plurality of sensors each produce associated sensor signals responsive to respective characteristics of an environment. The sensor signals are propagated to the sensor input of the microprocessor. There is additionally provided a memory system coupled to the memory access port of the microprocessor for storing calibration data associated with the plurality of sensors. A communications arrangement is coupled to the output port of the microprocessor.

In one embodiment of the invention, the memory system is arranged to contain unique system identification data. In a further embodiment, the memory system is arranged to contain system time data.

Various types of sensors are employable in the practice of the invention. For example, the sensors can include a temperature sensor, a pressure sensor, and a chemical sensor. In some embodiments, there is further provided a global positioning module coupled to the microprocessor for providing spatial location data. Such data may be three-dimensional so as to include, in an aquatic embodiment of the invention, tidal and wave height information.

The communications arrangement, in some embodiments of the invention, includes a network link. Also, a controller arrangement can be coupled to the network link.

In an aquatic embodiment, there is provided a housing for enclosing the microprocessor and the memory arrangement. The housing can be configured to achieve a predetermined extent of buoyancy. As will be described herein, some embodiments of the invention are intended to float on the surface of the sea, other embodiments are intended to sink to the bottom of the sea and become embedded in the sediment of the sea floor, and still other embodiments are intended to float in the sea below the surface.

In an advantageous embodiment, the microprocessor is provided with a trigger input port for receiving an external triggering signal. Thus, the present invention can be configured to be responsive to other systems in a network environment. Additionally, the microprocessor is provided in other embodiments with a trigger output port for issuing a triggering signal. In such other embodiments, the system of the present invention will control other systems in the network.

There is provided in some embodiments a display system coupled to a display port of the microprocessor. The display system useful to display channel identification data and sensor calibration data.

In accordance with a further system aspect of the invention, there is provided a system for acquiring environmental data from a plurality of sensors, the system having a microprocessor having a sensor input for receiving data from a sensor, a memory access port for communicating with a memory system, and an output port for issuing data. A plurality of sensors produce sensor signals responsive to respective characteristics of an environment. The sensor signals are propagated to the sensor input of the microprocessor. There is additionally provided a memory system that is coupled to the memory access port of the microprocessor. The memory system stores calibration data associated with the plurality of sensors. An antenna arrangement is coupled to the output port of the microprocessor for transmitting the data issued by the microprocessor. Additionally, a housing encloses the microprocessor and the memory system and affording protection from the aquatic environment.

In an aquatic embodiment of the invention, the housing is configured to provide a predeterminable buoyancy. Additionally, the antenna arrangement is configured to transmit the data using a transmission protocol suitable for sub-aquatic data transfer.

In accordance with a method aspect of the invention, there is provided a method of coordinating data from a plurality of data sources. The method includes the steps of:

receiving environmental data from a plurality of environmental data sensors; storing calibration data associated with respective ones of the environmental data sensors;

producing timing data corresponding to time and date;

propagating the environmental data, the calibration data, and the timing data to a microprocessor; and

producing at an output of the microprocessor output data responsive to the environmental data and the calibration data.

In one embodiment of this method aspect of the invention, there is provided the further step of triggering the operation of the microprocessor from a remote triggering source. Moreover, the microprocessor can control other equipment or systems coupled thereto by producing a trigger signal responsive to the environmental and transmitting the trigger signal to an external system.

In some embodiments, the inventive method includes the step of controlling the operation of the microprocessor from a remote computer.

An embodiment of the present invention constitutes an instrument that will enable a researcher to collect data from a variety of sensors all simultaneously and on the same data file structure. A unique feature of the present inventive instrument is that it enables the collection of voltammetric, potentiometric, and amperometric data, along with data from types of sensors, all concurrently. The instrument will allow several voltammetric types of sensors to be interconnected and to collect the resulting data.

The various instrument embodiments of the present invention are enabled to be utilized in a variety of environmental areas that include marshes, water columns of fresh or salt water, ocean sediments, hydrothermal vents. Some embodiments of the invention are applicable to industrial applications, well monitoring, and chemical synthesis monitoring in the laboratory or in the industrial environments. In still further embodiments, data derived from standard atmospheric monitoring, including, for example, wind speed, air temperature, humidity, etc. is integrated into the present inventive system.

The unique and inventive voltammetric aspect of the present invention enables the collection of data from a variety of voltammetric techniques, such as, direct current, sampled direct current, linear sweep, cyclic, normal pulse, differential pulse, and square wave voltammetric methods of analysis. Also all stripping voltammetric methods are supported.

The instrument of the present invention will allow these techniques and their associated waveforms to be applied to many electrochemical cells in the environment simultaneously. The instrument collects data from other sensors, such as various types of thermocouples, RTD's, and other temperature recording devices. Other sensors including pH probes and other potentiometric instruments and sensors can be connected to the system of the present invention enabling a complete chemical and physiochemical understanding of the environment under study. Other sensors, light sensors, radiance meters, and all other commercial sensors can be integrated in one system allowing the coordinated and simultaneous collection of data that cannot be achieved with known systems. In addition to the data types discussed above, photographic information also can be collected along with all scientific data.

Data from the system of the present invention is collected, in some embodiments, on a standard secure digital (“SD”) card of any size or type including, without limitation, the standard SD card, the mini SD card, and the Micro SD card. The process of data storage in a specific illustrative embodiment of the invention is such that if the data collection is interrupted, or if there is a power interruption, all data that is received is preserved directly on the SD card itself. The SD card or other form of storage media is then removed and the collected data is readily made available at a processing computer or at a further storage system.

In accordance with a an aspect of the invention, a small microprocessor and or a memory device that is implanted into a sensor probe. This enables a sensor probe to become smart enough to maintain its calibration, identification, and other pertinent information. Data from the smart sensors is transferred to an external computer or data storage system via typical protocols, such as serial, serial peripheral interface (SPI), I²C, network, one wire transfer, etc. When coupled to a data collection system, the previously stored calibration data is read from the memory in the sensor probe. This calibration data can be updated at any time prior to the sensor probe's deployment.

Some commercially available sensors or probes can be updated to become smart sensors of the type herein described. These probes can, in some embodiments of the invention, be connected to an intermediate module that enables calibration and other programming to be effected within the module. The module facilitates signal conditioning and data storage.

Temperature—Any type of temperature measuring device, e.g., thermocouple, RTD (platinum resistance thermometer), etc. can be provided with a smart interface that is made a part of the temperature probe itself. In some embodiments of the invention, the output data of the thermocouple is scaled down using the inboard microcomputer prior to being propagated to an external computer data collection system. This is achieved by modifying the calibration of the sensor probe whereby calibrated data is produced. The need to monitor A/D counts, or to monitor a voltage that would need to be scaled and converted, is obviated, saving time and resources.

A group of sensors with voltage, current, or resistance output can be used with the present invention. The data to be delivered includes, for example, pressure, humidity, CO₂, O₂, light level information, potentiometric information, voltammetric information, pH, etc. In essence, any sensor that requires calibration, identification, or calibration curves to be stored can be used with the sensor system of the present invention.

Some of the features of the system of the present invention include:
Multiple channel data collection from a variety of sensors and probes.
The ability to collect data to a secure digital card, a compact flash card, or any other appropriate storage medium.
The collection of data from smart sensors.
Low power consumption for extended deployments.
Utility as a data collection device in a wide variety of environments, including harsh and inhospitable environments,
Utility as a data collection device in high pressure environments, such as at full ocean depth.

Some of the specifications and characteristics of a specific illustrative embodiment of the invention include:
16 channel data collection with selection of from 10 to 24 bit resolution on any channel.
Development of smart sensors that remember their respective calibrations.
Typical sensors available for use with the invention include thermocouples, pH, redox probes, light sensors, Seabird microcat inputs, etc.
8 programmable external triggers with repeatability.
External trigger control and contact closure start.
Low power consumption, less than 1 pA.
Universal power input from 3 to 60 volts dc.
Data storage in readily usable formats, such as Excel format with auto file incrementation.
In-situ to laboratory applications.
Network controlability with voltammetry application support.
   Some of the applications of the present invention include:
Hydrothermal vent monitoring with up to 16 separately calibrated thermocouples.
Water column monitoring.
Drifter with G.P.S.
Sediment profiling.
Monitoring of a biological habitat in environments that include, for example, the ocean floor, marshes, and fresh water.
Simultaneous monitoring of several key parameters of a laboratory experiment.

### BRIEF DESCRIPTION OF THE DRAWING

Comprehension of the invention is facilitated by the annexed drawing, in which:

FIG. 1 is a photograph of the main circuit board of a specific illustrative embodiment of the invention;

FIG. 2 is a screen print of a software system that is useful in the practice of the present invention;

FIG. 3 is a simplified representation of various applications of the present invention;

FIG. 4 is a block and line representation of a smart sensor system configured in accordance with the principles of the invention;

FIG. 5 is a simplified representation of a data logging system configured in accordance with the principles of the invention; and

FIG. 6 is a simplified schematic representation of a micro observatory system constructed in accordance with the principles of the invention.

### DETAILED DESCRIPTION

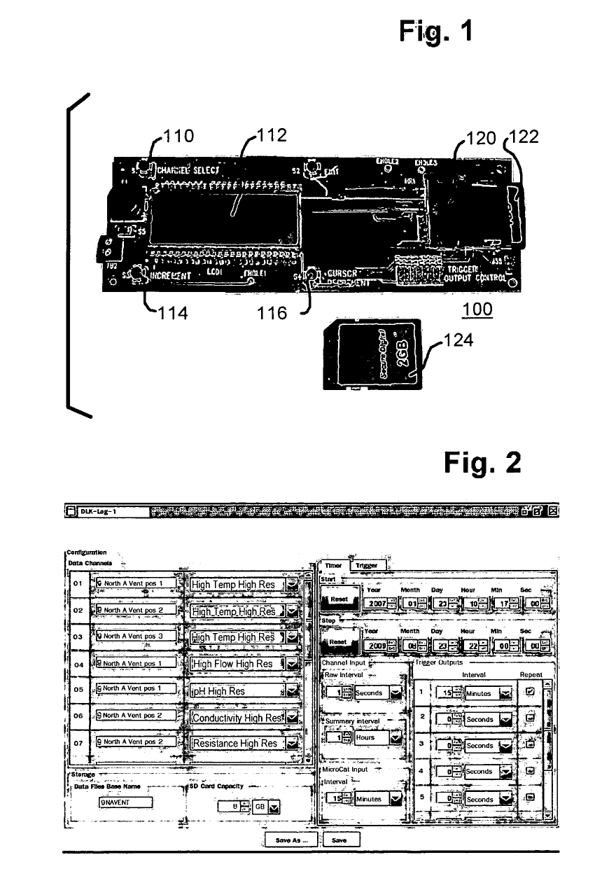

FIG. 1 is a photographic representation of a main circuit board 100 of a specific illustrative embodiment of the invention. As shown in this figure, main circuit board 100 of a data logging system (not specifically designated) constructed in accordance with the principles of the invention has a data channel selector control 110. The selection of the appropriate data channel is facilitated by a liquid crystal display (“LCD”) 112. LCD 112 additionally serves to facilitate the setting of system start and stop times, as will be discussed hereinbelow, and the calibration the selected channels. Other controls that are useful in relation to a stand-alone embodiment of the invention, such as data incrementation control 114 and data decrementation control 116, are also installed on main circuit board 100.

The collected data is stored in an appropriate storage medium. In this specific illustrative embodiment of the invention, there is provided a data card holder 120 that accommodates a conventional secure digital (“SD”) data storage card 122 and interconnects same to main circuit board 100. A further SD data storage card 124 is shown in this figure to facilitate visualization of the dimensions of main circuit board 100. More specifically, the physical size of main circuit board 100 in this specific illustrative embodiment of the invention is approximately 1.9″ by 5″.

FIG. 2 is a representation of a screen print of a data logging software system that is useful in the practice of the present invention. As shown in this screen print, data channels 01 through 07 are correlated with various positions and parameters to be 3 0 measured of “North A Vent,” which may, for example, be an undersea volcanic vent (not shown). Of course, other positions and parameters to be measured are accommodated in this software system, but are not shown in the illustrative screen print of this figure.

In this figure it is shown that, for example, data channels 01, 04, and 05 carry data related to the temperature, flow rate, and pH, respectively, at North A Vent position 1. Data channels 06 and 07, for example, carry data related to the conductivity and resistance, respectively, at North A Vent position 2. Various other features of this data logging software system are shown in the specific illustrative embodiment of the invention of FIG. 2, such as the selectability of start and stop times for the measurements desired to be taken.

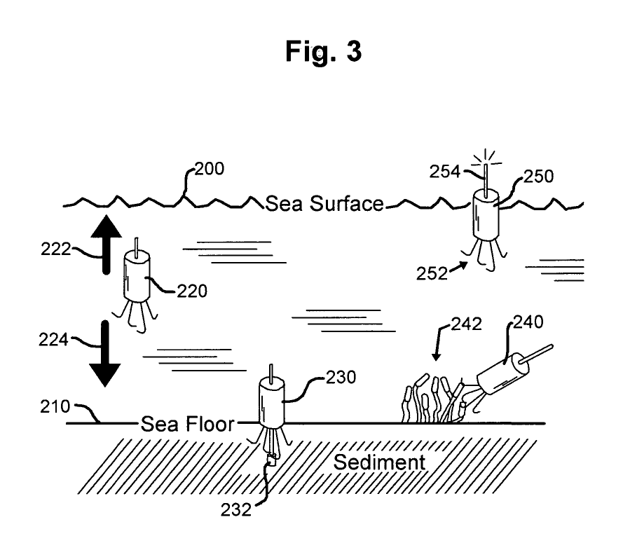

FIG. 3 is a simplified representation of various applications of the present invention in an aquatic environment. There is shown in this figure a sea surface 200 having a sea floor 210 that is formed of sediment. This figure shows as a specific illustrative embodiment of the invention a data logging arrangement 220 that is constructed in accordance with the invention. Data logging arrangement 220 is somewhat buoyant and can be displaced along the height of the sea as illustrated by arrows 222 and 224. This data logging arrangement, therefore, is configured to take data readings at various levels in the sea.

A further data logging arrangement 230 that is constructed in accordance with the invention is shown to be embedded in the sediment of the sea floor. This data logging arrangement is anchored to the sea floor by an anchoring arrangement 232 that also is embedded in the sediment. Data reading are obtained that identify the various characteristics of the sea floor sediment.

Still another data logging arrangement 240 that is constructed in accordance with the invention is shown to be in communication with undersea plant life 242. This data logging arrangement is useful, inter alia, to determined the manner in which plant life is affected by the aquatic environment, including the effluent from volcanic vents.

Data logging arrangement 250, which also is constructed in accordance with the invention, is shown to float on the sea surface 200. As described in relation to the other embodiments of the invention, this specific illustrative embodiment of the invention can log data relating to the quality of the sea water, as well as wave heights and current, illustratively with the use of an on-board GPS system (not shown). The data is collected by plural sensors 252, and such collected data, in this embodiment, is transmitted to a remote receiving station (not shown) via antenna 254.

As can be seen in this figure, data logging arrangements 220, 230, 240, and 250 are each enclosed within a housing (not specifically designated) that is configured to achieve a desired buoyancy. For example, data logging arrangement 250 is fully flotaional, while data logging arrangement 240 is not. Data logging arrangement 220, as previously noted, is partially buoyant.

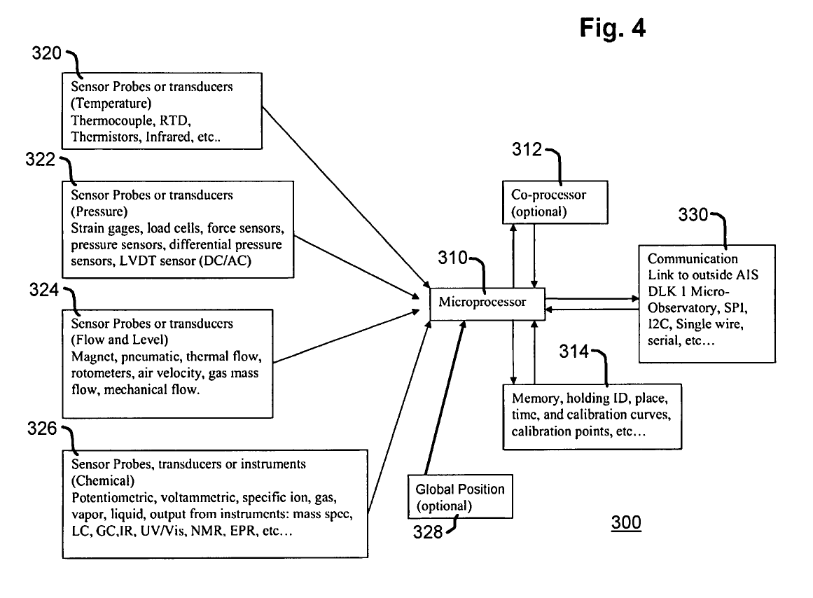

FIG. 4 is a block and line representation of a smart sensor system 300 configured in accordance with the principles of the invention. Smart sensor system 300 constitutes a specific illustrative embodiment of the invention that is based on a microprocessor 310. In this embodiment, there is optionally provided a co-processor 312. Microprocessor 310 operates in conjunction with a memory system 314 that contains in an associated memory location (not specifically designated) data that uniquely identifies the particular smart sensor system, which may be a data logging arrangement as previously discussed. Other information that is stored in the memory system of various embodiments of the invention include system position, system time, sensor and transducer calibration curves, calibration points, etc.

Some of the data that is stored in memory system 314 is obtained from sensors, such as sensors 320 to 328. In this embodiment, sensor 320 includes sensors or transducers that provide temperature data. These include, in various embodiments, thermocouples, thermistors, resistance temperature detectors, infrared detectors, and the like.

Sensor probes and transducers 322 provide pressure information and include, in this specific illustrative embodiment of the invention, strain gages, load cells, force sensors, pressure sensors, differential pressure sensors, linear voltage differential transformers, etc. Sensor probes and transducers 324 provide flow and level data, and include, for example, magnetic sensors, pneumatic sensors, thermal flow sensors, rotometers, air velocity sensors, gas mass flow detectors, and mechanical flow detectors.

Sensor probes and transducers 326 provide, in this specific illustrative embodiment of the invention, chemical data. Such chemical data is obtained, for example, from potentiometric sensors, voltammetric sensors, specific ion sensors, gas sensors, vapor sensors, liquid sensors, as well as the output from instruments, such as mass spectroscopy instruments, liquid chromatography, gas chromatography, infrared chromatography, ultraviolet and visual light analyzers, nuclear magnetic resonance, electrochemical potentiometer reactivation, etc.

In addition to the foregoing, there is provided in some embodiments of the invention a global positioning system 328 that provides to microprocessor 310 position information. In some embodiments, global positioning system 328 also provides three-dimensional data that can include tidal and wave height information.

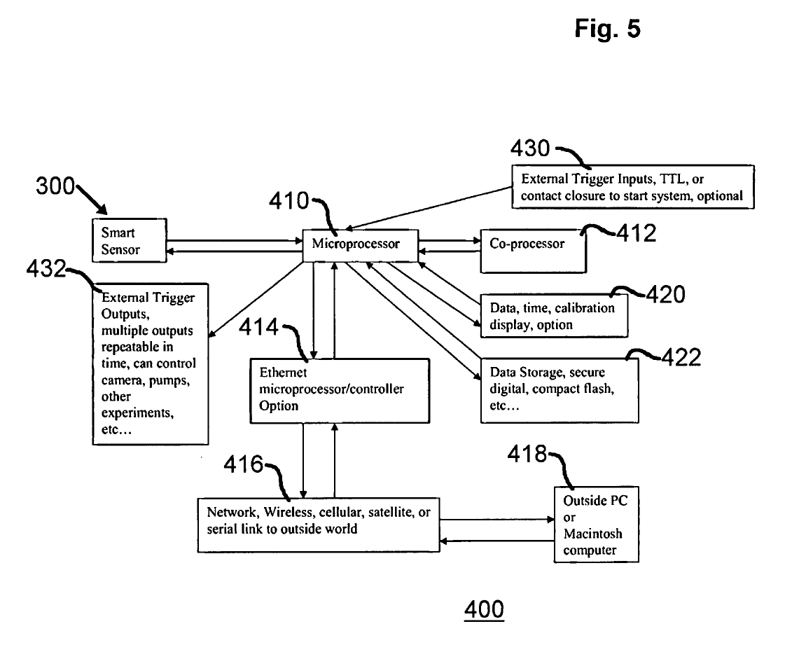

FIG. 5 is a simplified representation of a data logging system in the form of a micro-observatory system 400 configured in accordance with the principles of the invention. Elements of structure that have previously been discussed are similarly designated. Micro-observatory system 400 is configured around a microprocessor 410, that in some embodiments operates with a co-processor 412. Microprocessor 410 can, in some embodiments, be controlled via an ethernet network 414 that is itself coupled to a further network 416. Further network 416 can, in various embodiments of the invention, be a wireless network, a satellite network, a serial link, etc. The further network serves to couple microprocessor 410 to an external computer 418.

In some embodiments of micro-observatory system 400, there is provided a display 420 that facilitates the viewing of data, setting of the system time, calibration of various system parameters, etc. The resulting data is, in this specific illustrative embodiment of the invention, stored in a storage medium 422, which may constitute secure digital or compact flash form of memory. As shown, some embodiments of micro-observatory system 400 employ the data that is issued by smart sensor system 300, described hereinabove.

In still further embodiments, microprocessor 410 receives external triggering signals at external triggering input 430. Such external triggering can, in some embodiments, constitute transistor-transistor switching arrangements (not specifically designated), switch contacts, timers, etc. Such external triggers are useful to start and stop the operation of the system at desired points in time, including determination of timing gates to facilitate the capture of transient information. Similarly, microprocessor 410 can issue triggering signals at trigger output 432 that will control the operation of external equipment or systems (not shown). In some embodiments, the signals obtained at trigger output 432 are used to control the operation of cameras, pumps, or other equipment.

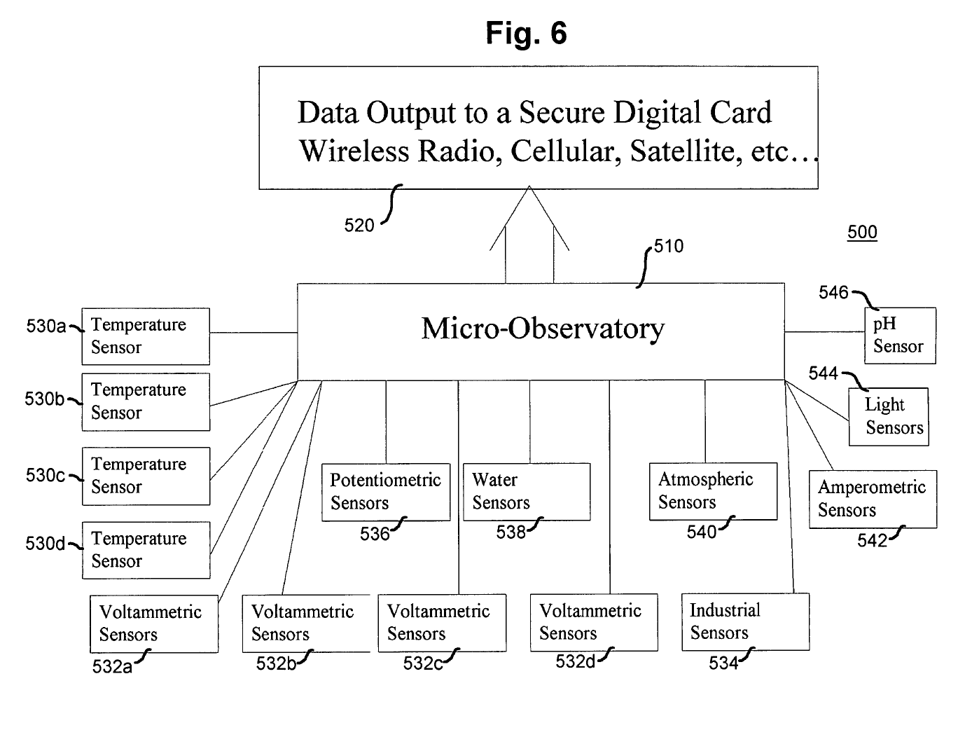

FIG. 6 is a simplified schematic representation of a further embodiment micro-observatory system 500 constructed in accordance with the principles of the invention. Elements of structure that have previously been discussed are similarly designated. In this specific illustrative embodiment of the invention, a micro-observatory 510 issues data to a data output arrangement 520, which can include any combination of a secure digital card (not shown in this figure), a compact flash card (not shown), wireless radio (not shown), satellite radio (not shown), cellular transceiver (nor shown), etc.

Data is supplied to micro-observatory 510 from a plurality of sensors and transducers, including, for example, temperature sensors 530a to 530d, voltammetric sensors 532a to 532d, industrial sensors 534, potentiometric sensors 536, water sensors 538, atmospheric sensors 540, amperometric sensors 542, light sensors 544, and pH sensors 546.

Although the invention has been described in terms of specific embodiments and applications, persons skilled in the art may, in light of this teaching, generate additional embodiments without exceeding the scope or departing from the spirit of the invention described and claimed herein. Accordingly, it is to be understood that the drawing and description in this disclosure are proffered to facilitate comprehension of the invention, and should not be construed to limit the scope thereof.

What is claimed is:

1. A system for acquiring environmental data from a plurality of sensors, the system comprising:
a microprocessor having a sensor input for receiving data from a sensor, a memory access port for communicating with a memory system, and an output port for issuing data;
a plurality of sensors for producing respectively associated sensor signals responsive to respective characteristics of an environment, said sensor signals being propagated to the sensor input of said microprocessor;
a memory system coupled to the memory access port of said microprocessor for storing calibration data associated with said plurality of sensors; and
a communications arrangement coupled to the output port of said microprocessor.

2. The system of claim 1, wherein said memory system is arranged to contain unique system identification data.

3. The system of claim 2, wherein said memory system is arranged to contain system time data.

4. The system of claim 1, wherein said plurality of sensors comprises a temperature sensor.

5. The system of claim 1, wherein said plurality of sensors comprises a pressure sensor.

6. The system of claim 1, wherein said plurality of sensors comprises a chemical sensor.

7. The system of claim 1, wherein there is further provided a global positioning module coupled to said microprocessor for providing spatial location data.

8. The system of claim 1, wherein said communications arrangement comprises a network link.

9. The system of claim 8, wherein there is further provided a controller arrangement coupled to the network link.

10. The system of claim 1, wherein there is further provided a housing for enclosing said microprocessor and said memory arrangement, said housing being configured to achieve a predetermined extent of buoyancy.

11. The system of claim 1, wherein said microprocessor is provided with a trigger input port for receiving an external triggering signal.

12. The system of claim 1, wherein said microprocessor is provided with a trigger output port for issuing a triggering signal.

13. The system of claim 1, wherein there is further provided a display system, and said microprocessor is provided with a display port for providing data to be displayed by said display system.

14. A system for acquiring environmental data from a plurality of sensors, the system comprising:
a microprocessor having a sensor input for receiving data from a sensor, a memory access port for communicating with a memory system, and an output port for issuing data;
a plurality of sensors for producing respectively associated sensor signals responsive to respective characteristics of an environment, said sensor signals being propagated to the sensor input of said microprocessor;
a memory system coupled to the memory access port of said microprocessor for storing calibration data associated with said plurality of sensors; and
an antenna arrangement coupled to the output port of said microprocessor for transmitting the data issued by said microprocessor; and
a housing for enclosing said microprocessor and said memory system and affording protection from the aquatic environment.

15. The system of claim 14, wherein said housing is configured to provide a predeterminable buoyancy.

16. The system of claim 14, wherein said antenna arrangement is configured to transmit the data using a transmission protocol suitable for sub-aquatic data transfer.

17. A method of coordinating data from a plurality of data sources, the method comprising the steps of:
receiving environmental data from a plurality of environmental data sensors;
storing calibration data associated with respective ones of the environmental data sensors;
producing timing data corresponding to time and date;
propagating the environmental data, the calibration data, and the timing data to a microprocessor; and
producing at an output of the microprocessor output data responsive to the environmental data and the calibration data.

18. The method of claim 17, wherein there is further provided the step of triggering the operation of the microprocessor from a remote triggering source.

19. The method of claim 17, wherein there are further provided the steps of:
producing a trigger signal responsive to the environmental; and
transmitting the trigger signal to an external system.

20. The method of claim 17, wherein there is further provided the step of controlling the operation of the microprocessor from a remote computer.
